(19) United States
(12) Patent Application Publication
(10) Pub. No.: US 2026/0257415 A1
(43) Pub. Date: Sep. 3, 2026

(54) A METHOD AND SYSTEM FOR PRODUCING A PRINTABLE OBJECT

(71) Applicant: RAYO 3D BIOTECH OY, Kalkkiranta (FI)

(72) Inventor: Pekka VALLITTU, Kuusisto (FI)

(21) Appl. No.: 19/165,375

(22) PCT Filed: Mar. 15, 2023
(86) PCT No.: PCT/EP2023/056598

§ 371 Date: Sep. 15, 2025

(51) Int. Cl. B29C 64/106; B29C 64/40; B33Y 10/00

(52) U.S. Cl. CPC B29C 64/106; B29C 64/40; B33Y 10/00; B29K 2995/0056

(57) ABSTRACT

Disclosed is a method for printing a 3D printable object, for example for a biomedical purpose, the method comprising: causing an injection tip (120) of a printing element comprised in a printing device to move at least horizontally within supporting material (115) such that the injection tip forms a cavern in to the supporting material, wherein the supporting material is complex fluid that has semi-solid gel-consistency and the cavern corresponds to the shape of the 3D printable object, injecting, using the injection tip, printing material (110) into the cavern, wherein the printing material comprises biodegradable or biostable resin or resin composite, and allowing a flow of the supporting material to cover the printing material after the movement of the injection tip.

### FIELD

The present disclosure relates to producing an object that is produced using additive manufacturing.

### BACKGROUND

In fabrication of 3D printed objects with diversity of shapes there may be shapes, or part(s) of shapes, such as overhangs, that may be critical overhangs, which cannot be balanced by the main body of the printable object and therefore printing material may collapse due to gravity. There are various attempts that may be used to overcome this issue, for example, printing the material in supporting bath and multichannel plotting by co-extrusion of temporary supporting material together with the main printing material. The first attempt has commonly a problem of contamination of the printing layers by the bath material which hinders layer fusion to each other, inadequate supporting effect against gravity and injection head clogging. The second attempt has its limitation in the need of removal of temporary supporting material from the actual printed object. Also, the temporary co-extrusion system does overcome the problems related to protect the printable material from negative effect for polymerization by ambient air. With the present technologies there may even be a need to print the object in several pieces and glue the parts together for one final object.

In fabrication of tissue engineering scaffolds, implantable or per os delivered drug releasing dossiers, tumor cell invasion scaffolds, soft and hard tissue replacing reconstructions, and other technical devices the shape indeed may comprise overhangs which limits their printing in one piece. In addition, when printing with bioink, which comprises cells or thermosensitive compounds, elevated temperatures of the printing environment including also the supporting bath can harm thermosensitive compounds and cells. This limitation may occur with the present bioink printing processes because several bioinks and supporting bath materials are based on thermoplastic polymers or thermos controlled viscous of hydrogels. In fact, many printing bath hydrogels may require elevated temperatures for having gel consistency and for being suitable for printing support. Furthermore, when the supporting material hydrogel is optimized for the viscosity for adequate supporting effect by increasing the temperature of the supporting material, the printable resin monomer systems which are polymerized by free radical reaction starts to polymerize too early which may cause problems of e.g. injection tip clogging.

### BRIEF DESCRIPTION

The scope of protection sought for various embodiments of the invention is set out by the independent claims. The exemplary embodiments and features, if any, described in this specification that do not fall under the scope of the independent claims are to be interpreted as examples useful for understanding various embodiments of the invention.

According to a first aspect there is a method for producing a printable object, the method comprising: injecting printing material using a printing element having one or several printing heads, each comprising an injection tip, that are movable, into supporting material, which may be environmentally friendly, and wherein the supporting material is complex fluid, semi-solid gel-consistency material in which the injection tip forms cavern shape path for the printing material when the injection tip moves horizontally in x-z directions. It is to be noted though that the injection tip may also be configured to move in vertical directions.

In an example embodiment according to the first aspect, the supporting material has complex fluid, semi-solid gel-consistency for supporting the printable material at the temperature and pressure which is suitable for the printable material.

In an example embodiment according to the first aspect, the cavern has width of the diameter of the moving injection tip and the formed cavern is filled with the printable material that is injected when the injection tip moves for example horizontally.

In an example embodiment according to the first aspect, movement of the injection tip causes local thixotropic drop of viscosity in the walls of the cavern and the cavern is closed by flow of the supporting material, and the printing material is covered with the supporting material which protects the printing material from the ambient environment but may accelerate polymerization.

In an example embodiment according to the first aspect the supporting material after being flown over the printed material protects the printed material from the polymerization inhibiting effects of oxygen and thus the printing object has well polymerized and glossy surface after being printed and polymerized in the supporting material.

In an example embodiment according to the first aspect, the supporting material has low Poisson ratio and the volumetric change of the supporting material due to volume of the injection tip and injected material takes place in vertical direction toward ambient air.

In an example embodiment according to the first aspect, the supporting material's composition and gel-consistency lowers turbulent fluid flow when the injection tip moves in the supporting material.

In an example embodiment according to the first aspect the force transmitted to the injection tip by movement of the injection tip exceeds the yield shear strength of the supporting material and thus the supporting material does not deform the injection tip.

In an example embodiment according to the first aspect, the supporting material comprises molecular, solid, emulsion additives, or gas bubbles which enhance Mie and Raleight type scattering to take place when the light is directed to the supporting material. The scattering distributes the light and reduces intensity of light radiation to reach the head of the injection tip, and hinders clogging of the injection tip when the injected material is photopolymerizable.

In an example embodiment according to the first aspect, the supporting material has gel-consistency which holds the protecting gas of polymerization of the injected material evenly distributed, and thus the supporting material hinders the gas to escape from the material to the ambient atmosphere.

In an example embodiment according to the first aspect, the supporting material has gel-consistency which holds diffused oxygen or oxygen gas bubbles evenly distributed in the supporting material providing oxygen for living cells throughout the supporting material.

In an example embodiment according to the first aspect, the printable material may be invaded by cells or compounds from the supporting material when the supporting material is having a second role as cell culturing medium or reservoir of substances to be incorporated to the printable object.

### BRIEF DESCRIPTION OF THE DRAWINGS

FIG. 1 illustrates printing material injection to the supporting material and formation of cavern for the printing material when the printing head moves horizontally.

FIG. 1 also illustrates closing the cavern by flow of the supporting material from the walls which covers the printing material with the supporting material.

FIG. 2 illustrates the closing time of the cavern in the supporting material with various quantities of sucrose in the supporting material.

FIG. 3 illustrates quantity of clogged material in the injection tip when the supporting material contains various amounts of sucrose.

FIG. 4 illustrates printing of melt thermoplastic printing material which solidifies in the supporting material.

FIG. 5 illustrates printing a hollow object where the supporting material with its components are encapsulated.

FIG. 6 illustrates a variation of the printing system/method of the example embodiment illustrated in FIG. 1.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only as to a single embodiment. Single features of different embodiments may also be combined to provide other embodiments.

One group of materials which has good physical properties and has been employed in additive manufacturing (AM), which may be used in 3D printing, are resin-based materials, resin-based composites and hydrogels. These materials can also be processed by several kinds of AM techniques. However, there may be some limitations in some of the present AM techniques to fabricate complex shaped objects and those which require good biocompatibility and surface quality. In bioprinting the group of materials which is commonly applied as bioink is hydrogel. Hydrogels or other gel-like materials can also be considered as supporting bath materials, hereafter as supporting material.

In gelation of hydrogel, called also aquagel, water is trapped within the gel forming substance network. Gels in general are complex fluids which are characterized of binary mixtures that have coexistence of two or more types of matter: solid-liquid, liquids-gas, liquid-liquid. Additives can modify the gel network formation and cause leakage of the trapped liquid from the space between the gelling agent. This can lead to syneresis and increased viscosity of the gel. Gels show also a property of thixotropicity which states that gels become fluid when shaked or otherwise physically stressed of mixed but they again become solid when place them at rest.

A hydrogel, called also as aquagel, is a cross-linked hydrophilic polymer system that does not dissolve in water. In gelation of hydrogel called water is trapped within the gel forming substance network and there are intermolecular association on the polymer chains. Hydrogels possess physiochemical properties that make them suitable for wide range of biomedical applications. Hydrogels are used also as biomaterial in soft tissue augmentation because of their highly viscous nature resembles natural soft tissue. In addition, hydrogels can be loaded with biologically active substances and cells and are used as printable material called bioink in AM technologies. Hydrogel's consistency and viscosity can be controlled by temperature. In some hydrogels the viscosity increases by increasing the temperature in some other it is opposite. Hydrogels have low mechanical strength and thus may not be suitable to be used as load-bearing implant but can be used as scaffold in tissue engineering where high strength is not needed. However, hydrogels can be cross-linked for retaining its shape.

There are several 3D printing techniques, devices and resins available which are used to fabricate tissue engineering scaffolds, implants, implantable or per os delivered drug releasing dossiers, dental constructs and even living cell constructs. 3D printing can be used also in tumor cell invasion scaffold fabrication which are used in cancer drug development and testing. An example of fabrication of biostable device is the use thermoset monomer system in implants and dental restorations. Printed material is mono or multifunctional acrylate or methacrylate monomer system or filler comprising resin composite. On the other hand, biodegradable resin-based materials may be preferred for tissue engineering scaffolds and drug releasing dossiers. Monomers harden in polymerization by free radical polymerization, cationic polymerization, cationic photopolymerization or frontal polymerization which are reactions inhibited e.g. by oxygen, which can be understood as ambient oxygen. For having complete hardening, i.e. degree of cure called monomer conversion (DC) of the monomers from inner part to the surface, oxygen should not be present in the curing process. Negative effect of ambient oxygen may be hindered for example by using oxygen protective barrier before final curing of the object is performed. One oxygen protective barrier in AM techniques is the supporting material which can comprise diffused gas or gas bubbles of polymerization protection gas. Ideally the protection gas should be evenly distributed to the supporting material and retain the gas in the supporting material throughout the period of the printing process. This can be obtained by the tailoring the consistency and viscosity of the supporting material for not allowing gas to escape too fast from the material. By too fast it is meant the time of the printing process which can vary from few seconds to several days for example.

Key issue in all 3D printing processes is support of the printing object for initial fixation of the printable material to the supporting platform and during printing the material layer-by-layer. In fabrication of 3D printed objects with diversity of shapes the critical overhangs, in some examples, cannot be balanced by the main body of the printable object and consequently, the printing material collapses due to gravity. One attempt to overcome this problem is to multichannel plotting of temporary supporting material together with the main printing material. The system is called a polyjet printing system. As an example, in the polyjet 3D printing a separate supporting material can be printed simultaneously with the printing material. Supporting material will then be an integrated part of the printable object and needs to be removed afterwards. After removal the polyjet supporting material, the printed object has a sticky polymerization inhibited, non-gloss and not biocompatible surface due to the printing process which has occurred in ambient air.

An alternative method for printing is to inject the material in the non-solid supporting material. The supporting material may be fluid, complex fluid, colloid, gel or semi-solid material. A system using this method can be used for example to deposit and cross-link bioink of mixture of cells, supporting matrix, nutrients to create tissue-like constructs. The bioink for example may be printed into gel poloxamer, which is poly(ethylene oxide)-poly(propylene oxide)-poly(ethylene oxide) triblock copolymer (PEO-PPO-PEO) biocompatible gel supporting the printing bioink. When the poloxamer gel and other gels are used as supporting material for 3D printing with printing material that is of thermoset monomers or composites with the robocasting technique, the gel may however contaminate the surface of printing layers and the printing layers may therefore not adhere to each other via polymerization, which may cause a weak construct of the printable object. In addition, movement of a printing tip of in the supporting gel may cause turbulent flow and unsteady vortices which are causing inaccuracy to the printing objects which is formed from the printing material. Fluid dynamics in the supporting liquids may also cause movement of the supporting material itself which deforms the printed object by stretching.

Thus, it would be beneficial to have a system and/or method, that may be at least partly controlled using a computing device, to produce printable objects that have the planned form and dimensions by printing material in extrusion injection technique. Printing the material to the supporting material which have consistency and viscosity at room temperature and pressure (RTP), physiological temperature, or at the temperature suitable for the printing material to be processed and which allows the injection tip of the printing device to move freely, to support the printing material against gravity and lateral spreading and to eliminate influence of oxygen inhibition of free radical polymerization on the surface of printable material is desired.

In an exemplary embodiment of a desired supporting material system, the supporting gel-consistency material allows tip of the printing tip to form a cavern to the supporting material when the tip moves horizontally. Force required to form the cavern should be such low that the tip of the injection head is not deformed. Thus, the shear stress to cut the supporting material and to form the cavern should be lower than stress to deform the injection tip.

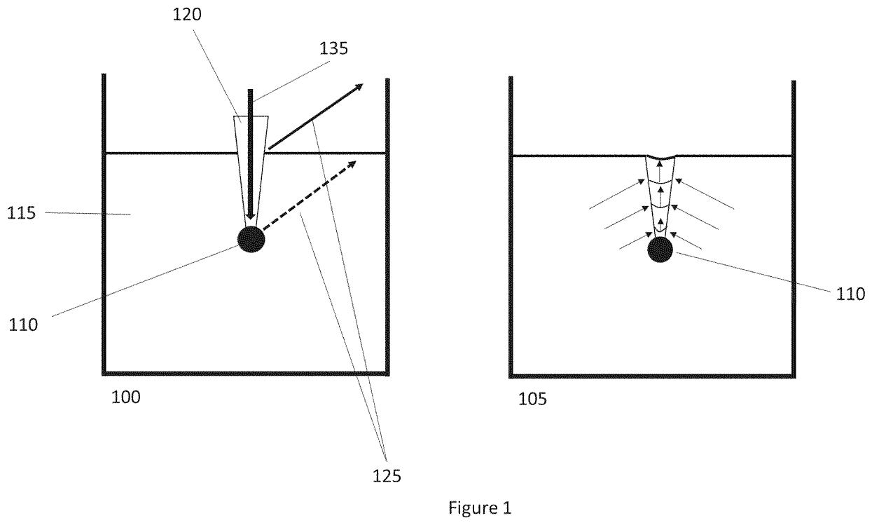

FIG. 1 illustrates an exemplary embodiment of such a system that is configured to implement a method for producing a printable object using 3D printing. In this example embodiment, the system comprises a printing device that may comprise or be connected to a computing device that may be caused to execute computer instructions such that the printing of the printable object is controlled at least partly by the computing device. Further, the printing device comprises one or more printing heads, each comprising an injection tip. In the FIG. 1, one injection tip is illustrated. The system in this example embodiment comprises a conical cylinder shaped injection tip 120 of the printing device which moves horizontally in the direction of arrows and cuts a cavern to the supporting material 115 into which the printing material 110 is injected using the injection tip. This is illustrated in the scenario 100 of the FIG. 1. FIG. 1 also illustrates in the scenario 105 the event behind the horizontally moving injection tip after a time period of approximately 0.5 to 60 seconds when the supporting material 115 flows from the walls of the cavern (side arrows) and covers the printable material 110 protecting the material from effects of oxygen inhibition of the ambient air.

Gradually the cavern is fully filled due to locally induced thixotropy of the supporting material by the moving injection tip (vertical arrows).

The printing material 110 may be biodegradable or biostable resin or resin composite of one of several functional reactive groups comprising polymerizable monomer or co-monomer system with compounds allowing addition or condensation polymerization: free radical polymerization, ionic polymerization, ring opening polymerization or frontal polymerization of the resin or resin composite. After polymerization the resin can be either thermoplastic, thermoset, copolymer, blend or interpenetrating polymer network (IPN) of any kinds. The printing material may also be a cross-linkable hydrogel or elastomer. It is also to be noted that the printing material may additionally comprise additional substances or materials.

The supporting material 115 is, in this example embodiment, complex fluid gel-consistency liquid which supports the printing material 110 against gravity, lateral spreading, protects the printable material's polymerization from oxygen inhibition, keeps the intentionally applied gas (protecting gas for free radical polymerization of the printable resin or oxygen for living cells of the printable bioink) evenly distributed in the supporting material during the printing event and in the case of photoinduced polymerization scatters the polymerization light to be not directly focused to the region of the injection tip which lowers risk for clogging of the injection tip.

The supporting material 115 is, in this example embodiment, gel-consistency material of any kind like hydrogel of ethyl or methyl cellulose (MC) (C₆H₇O₂(OH)ₓ(OCH₃)_{y}) or carboxymethyl cellulose in concentration of 0.5 to 50.0 wt-% in water, being preferably 5 wt-%. Biocompatible MC of homopolymer comprising glucose units by beta-1,4 bonds and methyl substitution degree of 1.6-1.8 making the MC soluble in water at RTP. Thus, MC is water soluble, and it is used as binder or thickener in pharmaceutical and food applications. MC is cellulose ester such as hydroxypropylmethylcellulose, hydroxyethylcellulose and carboxymeyhylcellulose. Due to its viscosity properties and biocompatibility (Inactive Igredients Search for Approved Drug Products/FDA) MC hydrogel is used as bioink in extrusion based printing. When heated MC gels in water and it is of thermoreversible nature. However, MC hydrogel is not a gel at RTP or physiologic temperature (37° C.) which would be desired for bioprinting and 3D printing of free radical polymerizable resins and resin composites, or thermoplastics which need to be cooled and solidified by the low temperature supporting material gel.

At RTP MC hydrogel has not a gel viscosity and shows only limited capacity to support the printing material 110 against gravity and lateral spreading and also turbulent fluid flow by force by the movement of the injection tip 125 cause dimensional inaccuracies to printable object. To avoid aforementioned problems the consistency of the supporting material 115 like MC-hydrogel can be adjusted by addition of molecules or colloidal particle systems. One suitable consistency modifier is disaccharide of glucose and fructose (sucrose) or difructose anhydride (caramel), lactose, maltose, galactose or liquid sugar which in the concentration of 0.5-99% which change the consistency of hydrogel to be more jelly-like but enables movement of the injection tip 125 in the material and shear force cutting a cavern to the material.

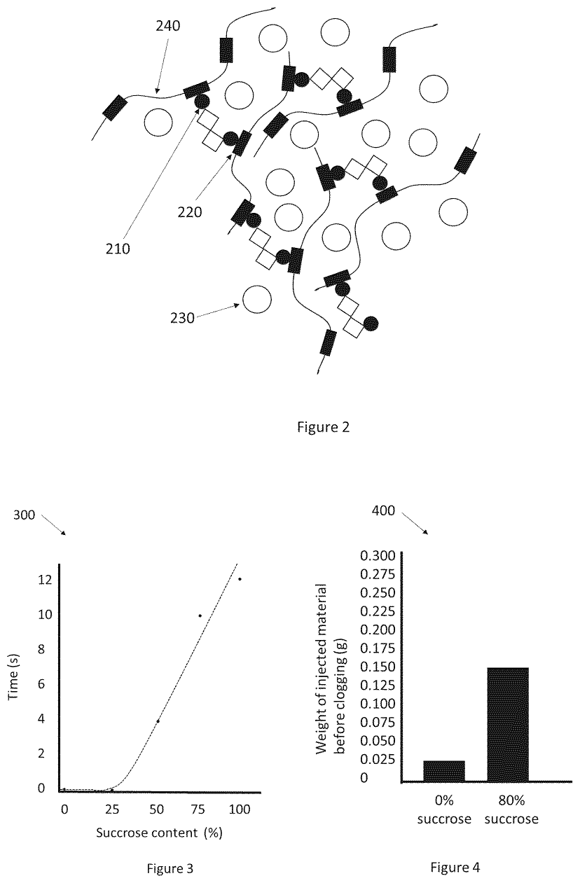

When addition of sugar to the MC hydrogel at RTP is used, it is intended to support MC's polymer chains to interact and form intermolecular association of the MC's alkyl group of methyl groups of the polymer chains which is spontaneously taking place at the temperature of above 42.5° C. FIG. 2 illustrates intermolecular association 200 of MC with degree of methyl substitution (DS) of 1.7-2.0 making the MC water soluble and to have polymer chains enabling to form high viscosity gel at RTP. Gelation of MC in water at RTP takes place when the dissolution of sucrose in water and MC hydrogel mixing with water are done simultaneously. Hydroxymethyl groups 210 of the dissolved sucrose form weak chemical interaction with the methyl group 220 of the MC polymers and the water molecules 230 are entrapped to intermolecular structure of MC polymer chains 240. Consequently, the formed environmental and biocompatible MC-sucrose hydrogel is having gel viscosity to be used in applications where such viscosity is needed at room's or physiologic temperatures.

In the application of supporting material for 3D printing, the cavern should be closed for protecting the printable material from the effects of ambient gas like air. In the MC-hydrogel a suitable quantity of sucrose for obtaining the aforementioned properties is 80 wt %. FIG. 3 illustrates a graph 300 regarding the effect of increasing the sucrose content of MC hydrogel to time of spontaneous closing of the cavern at RTP. 80 wt % sucrose content of the MC hydrogel supports the printing material of dimethacrylate resin composite against gravity and lateral spreading.

Sucrose disaccharide molecule (C₁₂H₂₂O₁₁) with its dimeter of ca. 20 ångtsröm (2 nm) crystallize to some extend in MC-hydrogel and reaches the size of colloidal particles where sucrose nanoparticles especially at lower temperatures starts to scatter the light (Tyndals effect) which is used in photopolymerization and cross-linking the printable material with a typical light wave length of 465 nm. Light scattering hinders direct light to be focused to the region of the injection tip, lowers local light intensity and power and thus hinders clogging of the injection tip to occur during photopolymerization of the injecting material. Thus, a printing system such as described above may utilize light scattering. FIG. 4 illustrates a graph 400 regarding an amount of printing material of particulate filling resin composite which can be injected to MC-hydrogel with and without 80 wt-% sucrose addition before clogging of the injection tip occurs in the set up where 465 nm LED curing light device radiation (ca. 900 mW/mm²) from 30 mm distance in an erlenmeyer glass is directed to the injection tip. If the MC-hydrogel, which is in this example the supporting material, with sucrose ccomprises also micro gas bubbles of protection gas like nitrogen or argon the light scattering is enhanced.

MC hydrogel supporting material with sucrose as viscosity modifier at low temperatures (RTP) allows thermoplastic polymers after melting to be printed to the supporting material. FIG. 5 illustrates a modification of the printing system described in the example embodiment of FIG. 1. In this example embodiment, there is the printing material 510 and supporting material 515, which in this example embodiment is temperature controlled. The printing material 510 has direction 535 and is thermoplastic and heated printing material which is to be solidified in a low temperature of the supporting material. In this example embodiment, there is also a thermoelement 540 that keeps the supporting material cool and sucrose provide jelly consistency. In this example embodiment, printing of the printing material 510, which is polycaprolactone (PCL), is performed by the system after being melted at the temperature of 60° C. in the injection tip, and the printing material 510 is then injected to the supporting material 515 which has the supporting jelly-like viscosity at temperature of 20° C. When the melted printing material 510 reaches the lower temperature supporting material 515, solidification takes place and the printed object receives the intended shape and dimensions. The direction of the movement of the injection tip is illustrated by the arrows 525 and the support by the supporting material 515 is illustrated using the arrows 545.

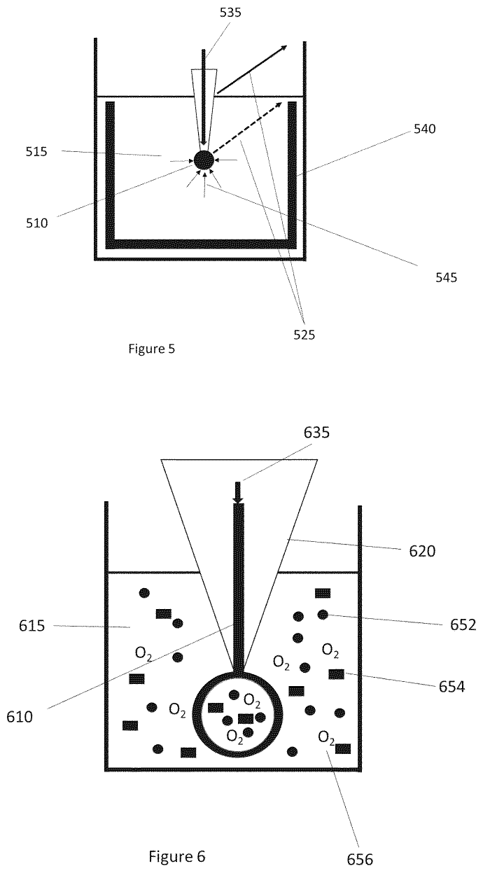

MC hydrogel with sucrose additive and physiological oxygen (O₂) partial pressure may be used as tissue engineering medium. Oxygen partial pressure (headspace O₂) level is ca. 18%. FIG. 6 illustrates another variation of the printing system/method of the example embodiment illustrated in FIG. 1. In this example embodiment, the supporting material 615 is MC-sucrose supporting material, which acts as cell and tissue culturing medium which comprises ingredients including sucrose 654 and O₂ 656 for cells' wellbeing. The supporting material 615 may also comprise drugs or other biologically active compounds 652. When a hollow structure like ball or closed cylinder is printed, by the injection tip 620 injecting the printing material 610 in the direction 635, the supporting material 615 with cells and ingredients are trapped inside of the printable object. When the printable material is biodegradable or resorbable, the printable object which can be implantable device or drug releasing dosier release the cells and active compounds to the region of interest in the target e.g. to start healing tissue defect or disease.

MC hydrogel can also be used as reservoir for living cells to be used in drug development for testing effect of the drug against cancer cell invasion. MC supporting material which contains cells like cancer cells and sucrose as the viscosity modifier at the temperature of 37° C. is used to print predetermined sized and shaped object of printable materials of matrigel or myomagel (Myogel). Without an effective drug against cancer cells the cells invase from the supporting material, proliferate and migrate to the printed object of matrigel or myogel. On contrary, if the drug is effective against cancer cells, the invasion of cells to the printed matrigel of myogel object is inhibited. The cells' invasion to the printed object which demonstrates effect of the drug is studied microscopically, colorimetrically or by immunological means from the printable object. Precise shape and volume of the printable object by the jelly-like consistency of the supporting material is required to calculate the degree of cell invasion.

Other hydrogels than MH can also be adjusted for their viscosity by adding sucrose molecules or some other molecules. Non-ionic polyacrylamide (PAM) ((C₃H₅NO)ₙ)—water hydrogel (PAH), cellulose micro fibrils, cellulose nanocrystals, potassium salt, chitosan, alginate, polyvinyl alcohol, starch, gelatin water hydrogels can be adjusted for the required consistency for the application of 3D printing supporting material or bioink. Biodegradable hydrogels are natural-based hydrogels like polysaccharides (e.g. chitosan) and proteins (e.g. collagen), or synthetic such as poly(lactic acid) (PLA), poly(glycolic acid) (PGA) and polypropylene fumarate (PPF).

The MC-sucrose-hydrogel can be used due to its environmental nature as supporting material or printable material in 3D printing in all technical fields, due to its biocompatibility in all biotechnical and drug development and production field, and as food ingredient and food production.

Even though the invention has been described above with reference to examples according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A method for printing a 3D printable object, the method comprising:
causing an injection tip of a printing element comprised in a printing device to move at least horizontally within supporting material such that the injection tip forms a cavern into the supporting material, wherein the supporting material is complex fluid that has semi-solid gel-consistency and the cavern corresponds to the shape of the 3D printable object;
injecting, using the injection tip, printing material into the cavern, wherein the printing material comprises biodegradable or biostable resin or resin composite; and
allowing a flow of the supporting material to cover the printing material after the movement of the injection tip;
wherein the supporting material has gel-consistency and holds protective gas of polymerization of the injected material evenly distributed in the supporting material.

2. A method according to claim 1, wherein the movement of the injection tip causes local thixotropic drop of viscosity in the walls of the cavern.

3. A method according to claim 1, wherein a force transmitted to the injection tip by the movement of the injection tip exceeds the yield shear strength of the supporting material.

4. A method according to claim 1, wherein the supporting material has gel-consistency and holds diffused oxygen or oxygen gas bubbles evenly distributed in the supporting material.

5. A method according to claim 1, wherein the supporting material comprises molecular, solid, emulsion additives, or gas bubbles that enhance Mie Rayleigh type scattering of light and the method further comprises applying photopolymerization of the printing material.

6. A method according to claim 1, wherein the supporting material is hydrogel of methyl cellulose comprising added sucrose, and the supporting material is gel at room temperature and pressure, or in a physiological temperature, and wherein the method further comprises melting the printing material in the injection tip before injecting into the cavity.

7. A method according to claim 6, wherein the method further comprises keeping the temperature of the supporting material lower than the temperature of the printing material.
